(19) United States
(12) Patent Application Publication
(10) Pub. No.: US 2001/0048419 A1
(43) Pub. Date: Dec. 6, 2001

(54) Method of gray scale generation for displays using a binary weighted clock

(76) Inventor: Jessica L. Stevens, San Mateo, CA (US)

Correspondence Address: Lisa M. Yamonaco, Telegen Corporation, Suite 200, 1840 Gateway Drive, San Mateo, CA, 94404, US

(21) Appl. No.: 09/725,590

(22) Filed: Nov. 29, 2000

Related U.S. Application Data
(60) Provisional application No. 60/204,733, filed on May 16, 2000.

(51) Int. Cl. G09G 3/36

(52) U.S. Cl. 345/89

(57) ABSTRACT

A programmable pulse width modulation generator circuit and method for generating a pulse width modulated signal with a variable duty cycle. The generator circuit includes a data loading circuit for receiving a data word representing the desired duty cycle of the pulse width modulated signal to be generated. The data word comprises a plurality of data bits, each bit having at least one of a selected or unselected state. The generator circuit also includes a generating circuit coupled to data loading circuit for receiving a plurality of periodic pulse width modulated signals, and for generating a pulse width modulated signal by combining each constituent pulse width modulated signals that correspond to a data bit in the data word that indicates the selected state.

The present invention is related to the following co-pending U.S. patent application Ser. No.: ______ entitled “Method of Gray Scale Generation For Displays Using a Register and a Binary Weighted Clock;” ______ “Method of Gray Scale Generation For Displays Using a Sample and Hold Circuit With Discharge;” and ______ “Method of Gray Scale Generation For Displays Using a Sample and Hold Circuit With a Variable Reference Voltage.”

### FIELD OF THE INVENTION

The present invention relates to displays and more particularly to driving display pixels according to gray scale generation.

### BACKGROUND OF THE INVENTION

Most displays must support many levels of brightness, i.e. shades of gray or “gray scale”, for each pixel element. With the exception of the cathode ray tube, the cost of gray scale driver electronics is one of the largest component costs of a display system. This is because of the complexity of generating gray scale as well as the fact that there are far more gray scale drivers needed in a display than any other driver element.

For example, in an SVGA Field Emission Display, there are 800 columns, each column composed of 3 sub-columns (Red, Green and Blue) and 600 rows or lines. Each row requires a simple ON or OFF driver, essentially a twolevel driver, and there are 600 drivers required per display. Each sub-column, however, requires a gray scale driver that may be required to provide 256 or more different levels of brightness, and there are one gray scale driver required per each sub-pixel or 800×3=2,400 of these drivers required per display. Thus, if the row and column drivers cost exactly the same, there would still be a 4:1 ratio of costs due simply to the number of drivers. However gray scale drivers are actually much more expensive than simple two-level drivers since they contain significantly more circuitry and therefore the additional cost would be much greater than 4:1.

There are two methods of generating the differing levels of pixel brightness in a gray scale driver. The first method is to vary the output voltage or output current provided by the driver. The higher the voltage or current, the brighter the pixel brightness. However, when the brightness is less than maximum, the excess energy that does not go to lighting the pixel is dissipated across the driver, generating heat. This makes the driver expensive because it must dissipate this heat in order to properly operate and few drivers can be packed in one chip because of this heat problem. It is also very complicated and expensive to build a driver, which translates digital picture information into the varying output voltages or currents needed for gray scale. Additionally, when the pixel is driven at a low brightness level with reduced voltage or current, the pixel may not be driven at its full efficiency, causing reduced display efficiency and uneven pixel illumination and sharpness.

The second method overcomes these heat and efficiency problems by utilizing the fact that the human eye cannot perceive fast changes in brightness and therefore integrates, or averages, the total light received over time and “sees” an average brightness. In this method, known as Pulse-Width Modulation, the pixel is driven at maximum brightness for a certain period of time and then turned off for another period of time. Because the driver circuit is only fully on or fully off, a minimum amount of the energy is lost in the driver and the pixel is always on at full efficiency. By varying the portion of a cycle that the pixel is lit, the perceived brightness can be varied from barely on to fully on.

However, the circuits to accomplish this second method of gray scale are very complicated. As can be seen in FIG. 1A, a typical gray scale circuit includes a latch or shift register to store the binary gray scale number before it is used, a latch to store the active gray scale number, a counter to generate the time slots, a comparator circuit to determine if the counted number is less than, equal to or greater than the stored gray scale number, and a driver transistor.

In the operation of the circuit shown in FIG. 1A, the binary gray scale number is first stored in the latch or shift register for later transfer to the active latch. After the data is transferred to the active latch, the counter is reset to zero and then begins counting up to a maximum number, which defines one complete brightness cycle, defined as T in FIG. 1B. Each time the counter counts up, its output is compared by the comparator circuit with the gray scale number stored in the active latch. If the stored number in the active latch is lower than the count number from the counter, the comparator circuit will set the driver transistor to ON. When the gray scale number becomes equal to or greater than the count from the counter, the comparator circuit turns the driver transistor to OFF. The period of time when the driver is ON is shown as X in FIG. 1B. The overall brightness of the pixel in the typical gray scale circuit described in FIG. 1A is defined by the ratio of X to T shown in FIG. 1B, where X is defined as the time the driver is ON and T is defined as the total time period for one complete brightness cycle. This solution requires a large amount of circuitry to drive a pixel according to gray scale.

Therefore, there exists a need to reduce the amount of gray scale circuitry to drive a pixel for various types of flat panel displays.

### SUMMARY OF THE INVENTION

The present invention provides a programmable pulse width modulation generator circuit for generating a pulse width modulated signal with a variable duty cycle. The generator circuit includes a data loading circuit for receiving a data word representing the desired duty cycle of the pulse width modulated signal to be generated. The data word comprises a plurality of data bits, each bit having at least one of a selected or unselected state. The generator circuit also includes a generating circuit coupled to data loading circuit for receiving a plurality of periodic pulse width modulated signals, and for generating a pulse width modulated signal by combining each constituent pulse width modulated signals that correspond to a data bit in the data word that indicates the selected state.

In accordance with other aspects of the present invention, each constituent pulse width modulated signal has an ON portion that is unique during a common period shared by the constituent pulse width modulated signals. The ON portion of each constituent pulse width modulated signal is binary weighted so that the ON portion of each of the constituent pulse width modulated signals is related by a unique power of 2 to the ON portion of each other of the constituent pulse width signals.

In the present embodiment, the ON portions of the constituent pulse width modulated signals are ordered in time according to their binary weight, although in other embodiments the constituent pulse width modulated signals may occur in any order as long as no two pulse width modulated signal's ON portions overlap in time, each pulse width modulated signal's ON portion begins as the prior pulse width modulated signal's ON period turns OFF and all pulse width modulated signals together shall constitute one complete common or brightness period.

In the present embodiment, the constituent pulse width modulated signal having the ON portion with the greatest magnitude occurs at the end of the common period, although in other embodiments each pulse width modulated signal may occur at any location in the common or brightness period.

As will be readily appreciated from the foregoing summary, the invention provides an improved circuit for generating a pulse width modulated signal.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIGS. 1A and B illustrate gray scale circuitry and timing as performed by the prior art;

FIG. 2 is a flow diagram of the method of the present invention;

FIG. 3 is graph of a set of reference input signals used in the present invention;

FIGS. 4A and B are a graph illustration of selected reference input signals and a resulting pulse width modulation signal;

FIG. 5 is a diagram illustrating the present invention;

FIG. 6 is an example circuit diagram for implementing the logic diagram of FIG. 5;

FIGS. 7A and B is graph of a set of reference input signals; and

FIGS. 8A and B are example diagrams illustrating examples of the present invention.

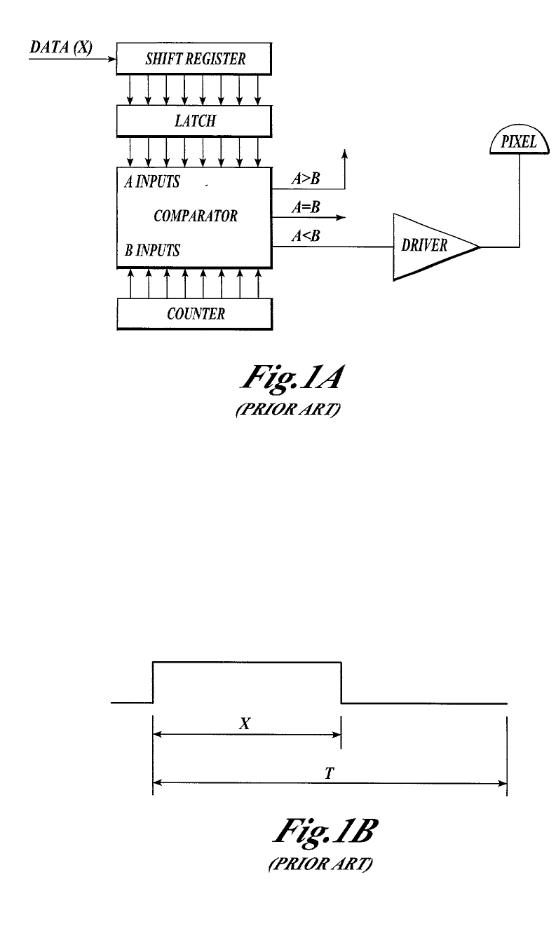

### DETAILED DESCRIPTION OF THE PREFERRED EMBODIMENT

The methods and circuits of the present invention provide a programmable Pulse Width Modulated (“PWM”) signal generator using considerably fewer gates than are presently required using the prior art methods described above.

In overview, the present invention comprises a programmable generation circuit to which a plurality of constituent PWM signals are input. When programmed with a data word that represents a desired duty cycle for the PWM signal to be output, the programmable generation circuit selects the appropriate constituent PWM signal(s) and adds them together to generate a composite output PWM signal. Because many programmable generation circuits can share the same constituent PWM signal inputs, considerably less circuitry is required to generate many output PWM signals than would be required using prior art methods.

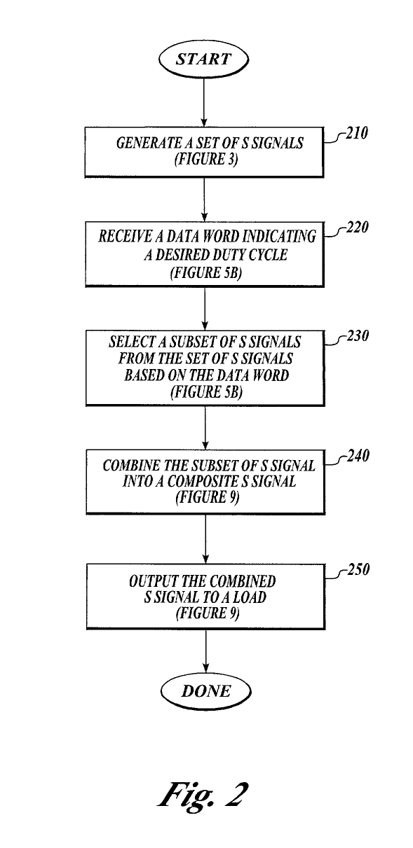

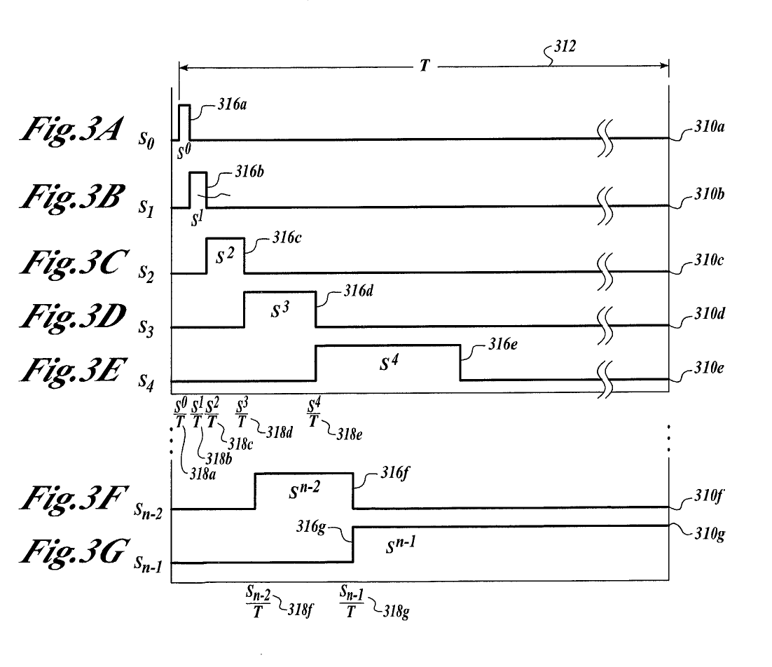

A method of the present invention is illustrated in FIG. 2. The method begins by generating a set of S signals, see block 210. Although there are alternative configurations discussed below, most often the S signals will be pulse width modulated signals that each contain a single pulse that has a unique duration and period during a total period referred to as an S-cycle. A data word is received at block 220. The data word indicates a desired duty cycle for a pulse width modulated signal that will be used to drive a load, such as a pixel driver. At block 230, the data word is used to select a subset of constituent S signals from the set of S signals generated in block 210. The selected subset of constituent S signals are combined at block 240 into a composite S signal. The composite S signal is output to a load at block 250. From the perspective of the load, which averages the pulses over time, the S signal appears as a pulse width modulated signal with a duty cycle approximately equal to the duty cycle called for in the data word.

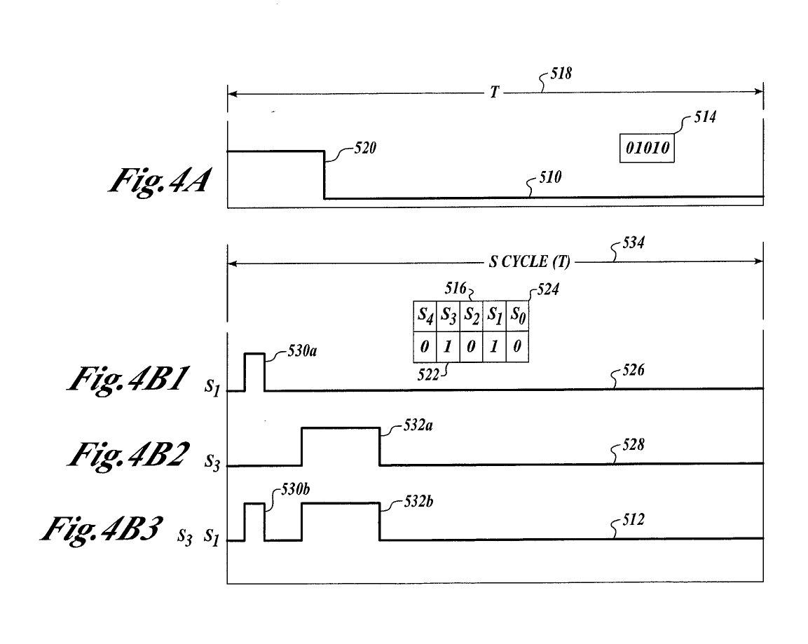

An exemplary composition of the constituent PWM signals (“S signals”) is illustrated in FIG. 3. These S signals may be advantageously used in digital computer systems, as the binary weighting of S signals particularly support this application. The weighting of the S signals can be performed various other ways while remaining within the scope and spirit of the invention.

In FIG. 3, each of the S signals 310a-g has a period which occurs during T 312. At particular times during the period T 312 , a pulse 316a-g is generated. The number (n) of S signals is theoretically unlimited, but is decided by the resolution requirements for controlling the duty cycle of the output PWM signal and is practically constrained by the space available for a transmission bus to couple the S signals to the programmable generation circuits. Each pulse 316a-g has its own unique place in time 318a-g during the period T 312. For example, in FIG. 3, S signal S₀ 310a occurs at time period S₀-1/T 318a, at the beginning of the T period, S signal S₁ 310b occurs at time period S₁-1/T 318b, immediately after S signal S₀ goes LOW, S signal S₂ 310c occurs at time period S₂-1/T 318c, immediately after S signal S₁ goes LOW, S signal S₃ 310d occurs at time period S₃-1/T 318d, immediately after S signal S₂ goes LOW, S signal S₄ 310e occurs at time period S₄-1/T 318e, immediately after S signal S₃ goes LOW, S signal S₅ 310e occurs at time period S₅-1/T 318e, immediately after S signal S₄ goes LOW, and so on, until the last two S signals in the series are positioned with S signal Sₙ₋₂ 310f occurring at time period Sₙ₋₂-1/T 318f, , immediately after S signal Sₙ₋₃ goes LOW and S signal Sₙ₋₁ 310g occurring at time period Sₙ₋₁-1/T 318g, immediately after S signal Sₙ₋₂ goes LOW. The pulses 316a-g do not require sequential placement as just described, but may be reordered in any pattern desired.

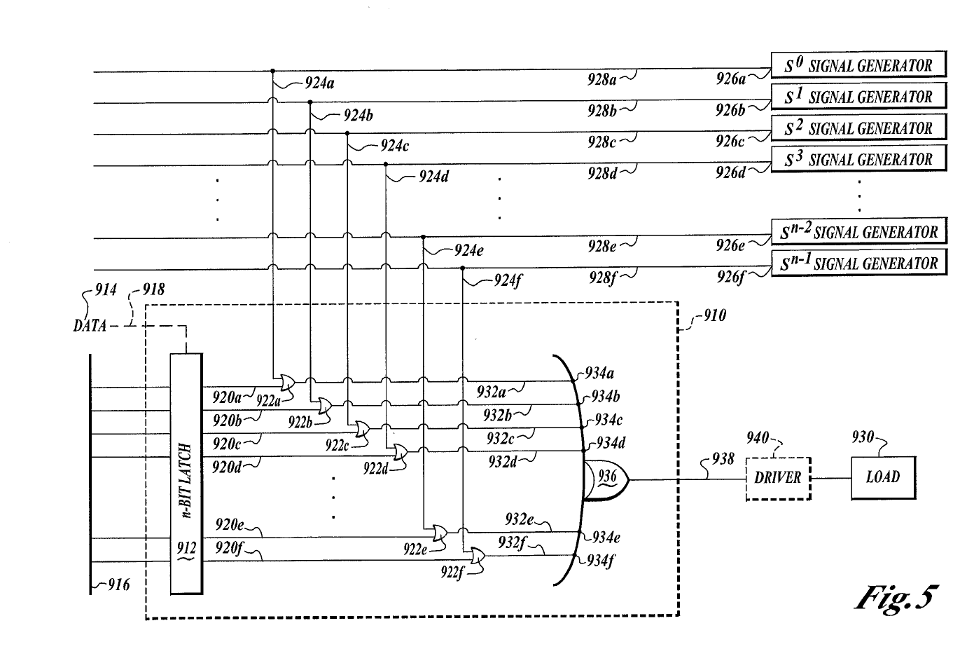

Power in a PWM signal is transmitted through the ON pulse length, which is averaged by the load over the total period (T) of the signal. The shape of a PWM signal 510 generated by the prior art for the given programmed value 01010 is illustrated in FIG. 4A and a functionally equivalent PWM signal 512 generated by the present invention is illustrated in FIG. 4B. The exemplary PWM signals in FIGS. 4A and 4B reflect a duty cycle specified in an exemplary 5-bit data word 514 and 516. In FIG. 4A, the data word represents a binary value of 01010 or decimal 10. Since the data word is 5 bits, the cycle time (T) for the PWM signal 510 is defined as T=2ⁿ, where n=the number of bits in the data word. Since the data word is 5 bits, T would be 2⁵ or 32 periods. The value in the data word reflects that the PWM should have a duty cycle of 10/32T, which is generated by the prior art in the manner described above, as a single pulse 520 with a duration of 10 periods. The power delivered by this pulse 520 is the cycle time T divided by the length of time that the pulse is ON or 10/32T. Instead of providing the circuitry at each PWM generator to generate a single pulse 520 with a programmed duration, the present invention employs a generation circuit to combine zero or more S signals into a PWM signal 512 with a desired total duty cycle. The S signals are generated elsewhere and contain pulses with known characteristics. For example, in FIG. 4B the data word 516 has a binary value of 01010 or decimal 10 522 whose positions are associated with S signals S₁ 526 and S₃ 528. S signal S₁ 526 has a pulse 530a with a period of 2 (2¹) and S₃ 528 has a pulse 532a with a period of 8 (2³). When constituent S signals S₁ 526 and S₃ 528 are combined by the generation circuit, the PWM signal 512 results and contains a pulse 530b with a period of 2 (2¹) and a pulse 532b with a period of 8 (2³). Since the power transmitted by the pulses 530b and 532b is averaged by the load, the total power transmitted by the PWM signal 512 in this example is defined as S^{tota}/T, where S^{total} is defined as the total S periods ON and T is defined as T=(2ⁿ−1), where n=the total number of S signals. In the example shown in FIG. 4B, T would be (2⁵−1) or 31 periods since there are 5 S signals and Sₜₒₜₐₗ would be S₁ pulse 530b with a period of 2 (2¹) and S₃ pulse 532b with a period of 8 (2³) or 10 periods. The total power transmitted by the PWM signal 512 would therefore be 2+8/31T or 10/31T. PWM signal 510 and PWM signal 512, therefore, have a functionally equivalent duty cycle.

It should be noted that in the present invention the total T cycle time is always one period less than the T cycle time in the prior art for the same given number of bits, causing a slight difference in the power delivered by the present invention for the same data word. For example, in a 5 bit system T would equal 32 periods in the prior art and 31 periods in the present invention. For an 8 bit system, T would equal 256 periods in the prior art and 255 periods in the present invention. This occurs because the counter circuit used to count the T cycle time in the prior art starts its cycle with a count of 0 for one period, while the present invention does not utilize a counter and begins its cycle with period 1, bypassing period 0. This small difference in number of periods in T between the prior art and the present invention is not noticeable to the human eye and would represent a difference of only 0.2% in power delivered in an 8 bit system between the prior art and the present invention.

In very low bit systems, where this difference may become noticeable and compatibility with the prior art is required, a single blank period in which no S signals are ON can be added to the T cycle to compensate.

The bits in the data word do not have to be in binary format and any coding pattern can be accommodated by the present invention by associating bit positions with S signals. In the example shown in FIG. 4B it is assumed that the data word is presented in binary format, and as such, since the data word is 5 bits, a cycle time (T) for the PWM signal 512 is divided into (2⁵−1) or 31 periods. The value in the data word reflects that the PWM should have a duty cycle of 10/31T.

The data word need not be ordered in any particular manner. The positions of the bits are mapped by bit assignment to the S signals. The present invention can accommodate any number of states for the bit values. The order that pulses appear in S cycle and the duration of the pulses need not be in a sequential or weighted format.

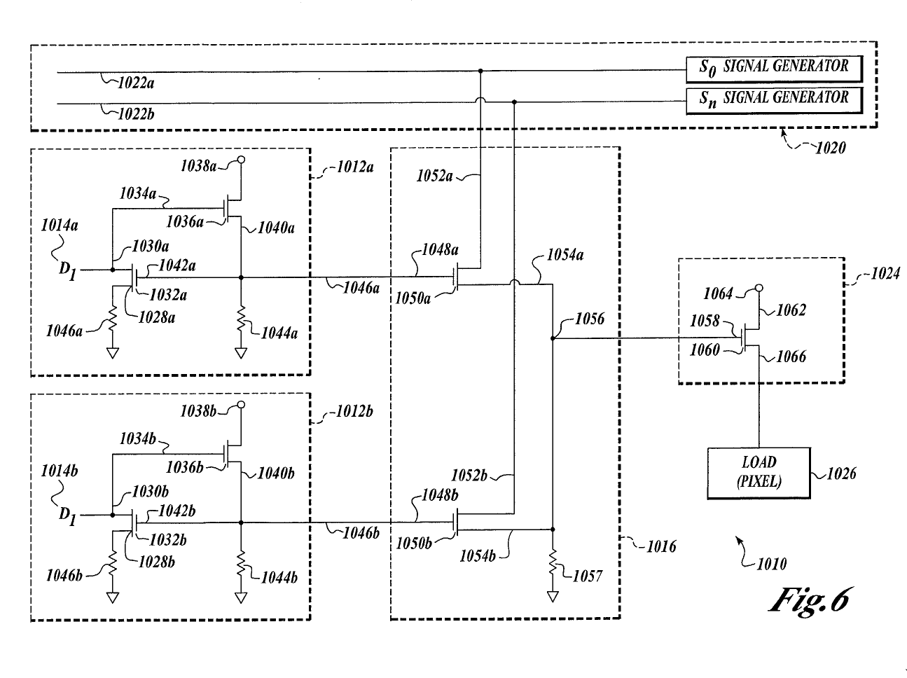

A generation circuit 910 is illustrated in block form in FIG. 5. The generation circuit comprises an n-bit data latch 912 which receives data 914 from a parallel data bus 916 or via a serial data line 918. When the n-bit data latch 912 receives serial data, it may be implemented as a serial to parallel shift register or a series of D flip-flops coupled in an equivalent manner. The data latch may be omitted when data is present on the parallel data bus 916 for a period that exceeds the S cycle (e.g., 312, FIG. 3, above). The n-bit data latch 912 may have any number “n” latches available, but generally n will equal the size of the data word used to program the generation circuit 910 for a duty cycle with the appropriate resolution. (Extra latches are used advantageously in an actual embodiment of the invention for controlling grayscale, described in detail below).

The data latch 912 is coupled to a first input 920a-f of a plurality of two input AND gates 922a-f. There is a two input AND gate 922a-f for each bit n in the data word. A second input 924a-f of the AND gates 922a-f are respectively coupled to S signal generators 926a-f (FIG. 5), generally through a bus arrangement 928a-f that supplies their respective S signals (FIG. 3) to many generation circuits 910 that each drive their own load 930 with a programmable PWM signal directly or through intermediate circuitry such as a power driver 940. An output 932a-f of each respective AND gate 922a-f is coupled to an n input 934a-f (or equivalent) OR gate 936. The OR gate may be implemented as a “wired-OR” to save circuitry, below. An output 938 of the OR gate 936 is coupled to the load 930 or intermediate circuitry such as a power driver 940.

An example electronic circuit 1010 incorporating the present invention is illustrated in FIG. 6. A plurality of data latch circuits 1012a and 1012b receive and store data D₁ 1014a-Dn 1014b from a data bus (not shown). The data latch circuits 1012a and 1012b are coupled to a generation circuit 1016. The generation circuit is also coupled to S Signal Bus 1020. Based on the individual states of the data latch circuits 1012a and 1012b, the generation circuit selects a corresponding zero or more corresponding S signals 1022a and 1022b, sums those S signals 1022a and 1022b, and couples the resulting summed S signal to a driver circuit 1024. A load 1026, such as a phosphor pixel, is connected to the driver circuit 1024.

In more detail, each latch circuit 1012a-b comprises a data input 1014a-b coupled to a drain 1030a-b of a transistor 1032a-b. The source 1030a-b is also coupled to a gate 1034a-b of a transistor 1036a-b. The source 1038a-b of the transistor 1036a-b is connected to a supply voltage (Vdd). The drain 1040a-b of the transistor 1036a-b is coupled to a gate 1042a-b of transistor 1032a-b and a resistor 1044a-b. A drain 1028a-b of the transistor 1032a-b is coupled to a resistor 1046a-b. The resistors 1044a-b and 1046a-b are also connected to ground. The transistors 1032a-b and 1036a-b latch the state of the data 1014a-b. While generally there will be a data latch circuit 1014a-b for each data bit in a data word, the present invention may have any number of data latch circuits. For example, additional data latch circuits may precede or supplement data latch circuits 1014a-b when pre-loading data is desirable.

An output 1046a-b from each data latch circuits 1012a-b is coupled to the generation circuit 1016 at a gate 1048a-b of a transistor 1050a-b. The source 1052a of transistor 1050a is connected to a S signal bus line 1022a for S signal S₀ and the source 1052b of transistor 1050b is connected to a S signal bus line 1022b for S signal Sₙ. The drains 1054a-b of each transistor 1050a-b are coupled together in a “wired-OR” configuration, represented by point 1056 and resistor 1057. Each transistor 1052a-b acts as a logical AND gate that selects its corresponding S signal when its gate 1048a-b is activated by the output 1046a-b of its corresponding latch circuit 1012a-b. Of course, there are alternative circuits to perform the functions of the invention that will be apparent to those skilled in the art. For instance, the transistors 1050a-b transistors may be replaced with integrated circuits that implement analog switches, AND, NAND or NOR gates. The wired OR portion 1056 and 1057 may similarly be replaced by one or more analog switches, OR, NAND, or NOR gates.

Once selected and combined by the generation circuit 1016, a combined S signal appears at the point 1056 and is coupled to the gate 1058 of a power transistor 1060 in the driver circuit 1024. The source 1062 of the power transistor 1060 is connect to a supply voltage 1064 and the drain 1066 of the power transistor 1060 is coupled to the load 1026 (e.g., a pixel).

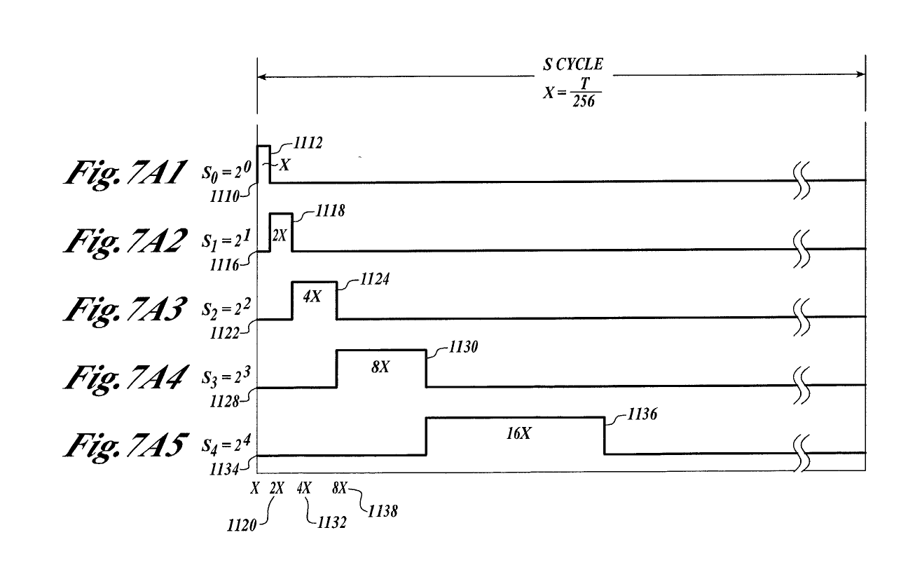

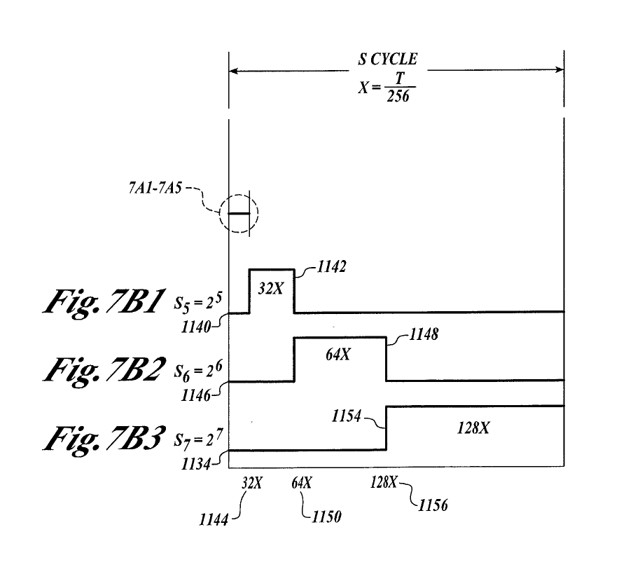

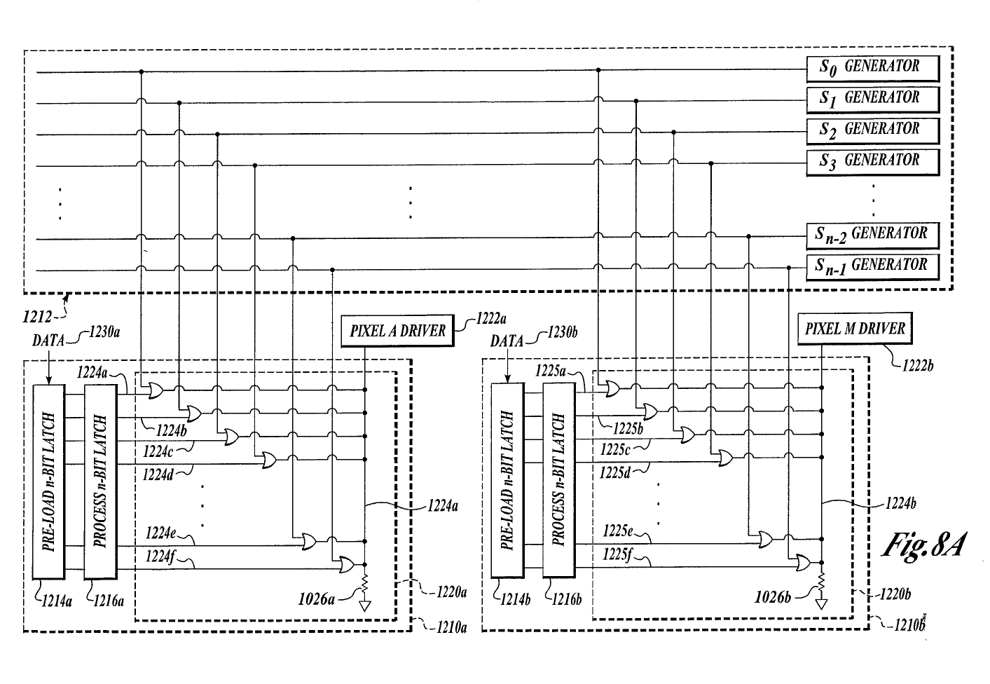

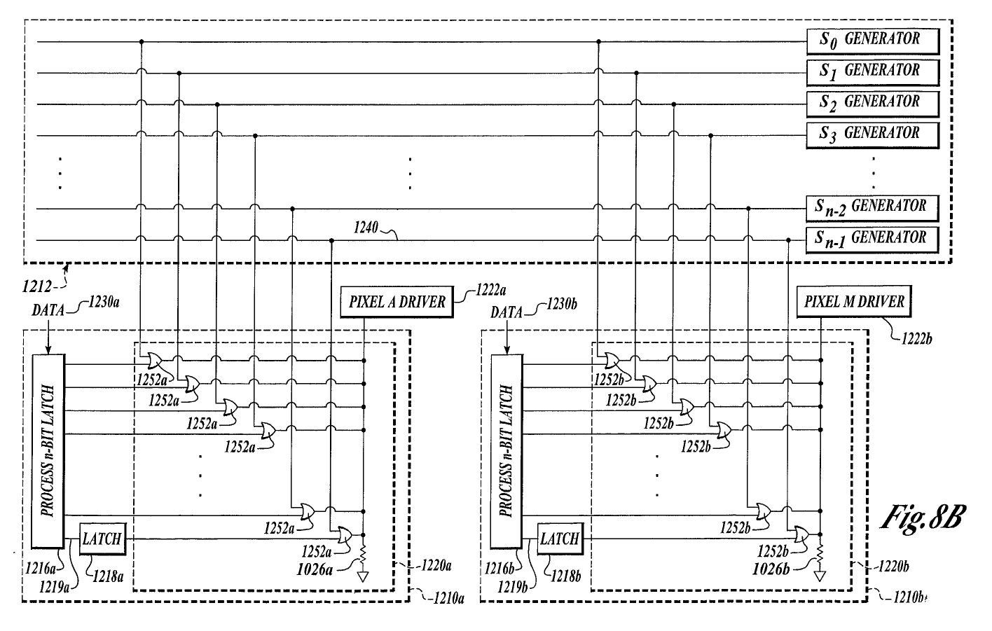

As described above, the methods and systems of the present invention are particularly well suited to provide a pulse width modulated signal to a pixel element in a display. The following embodiments of the present invention (illustrated in FIGS. 7 and 8) describe a gray scale driver for a pixel element in a display. To simplify the following discussion, it will be assumed that each pixel has a single monochromatic element having gray scale driven by the present invention. However, the following discussion can easily be applied to color systems. A color pixel includes three sub-pixels (RGB), each having their own gray scale and gray scale driver.

The following discussion also assumes that there are 256 (2⁸) levels of gray scale for each pixel. The gray scale for the pixel is specified by a data word with 8 bits. As described above, any number of gray scale levels can be accommodated by the present invention by adjusting the number of data bits in the data word and/or available S signals. The following is also described in the context of using the invention in a digital device, with the pulse width modulated signal moving between a HIGH and a LOW voltage. For convenience in generating, timing and correlating the S signals to the bits of the data word, the S signals are binary weighted.

As illustrated in FIGS. 7A-B, the S Signals are square wave signals generated by a specialized counter system with different duty cycles and starting times related in the following manner:

| | |
|---|---|
| Signal S₀ 1110 | 1X time period HIGH 1112 and starting immediately |
| | at the beginning of the cycle |
| Signal S₁ 1116 | 2X time periods HIGH 1118 and starting when 1112 |
| | Signal S₀ goes LOW |
| Signal S₂ 1122 | 4X time periods HIGH 1124 and starting when 1118 |
| | Signal S₁ goes LOW |
| Signal S₃ 1128 | 8X time periods HIGH 1130 and starting when 1124 |
| | Signal S₂ goes LOW |
| Signal S₄ 1134 | 16X time periods HIGH 1136 and starting when 1130 |
| | Signal S₃ goes LOW |
| Signal S₅ 1140 | 32X time periods HIGH 1142 and starting when 1136 |
| | Signal S₄ goes LOW |
| Signal S₆ 1146 | 64X time periods HIGH 1148 and starting when 1142 |
| | Signal S₅ goes LOW |
| Signal S₇ 1152 | 128X time periods HIGH 1154 and starting when 1148 |
| | Signal S6 goes LOW |
| | (For the next cycle, Signal S₀ 1110 repeats |
| | again immediately after 1154 Signal S₇ goes LOW) |

In this embodiment, there would be eight gray scale bits representing a possible 256 possible levels of luminosity (zero luminosity plus 255 levels of gray). The total HIGH period for all S Signals ORed together would be 255 times the HIGH period for Signal S₀ (this is known as the S Cycle time.) If a pixel is on for all of the entire S Cycle, it is then ON or HIGH for 100% of the time period since the cycle starts again after S₇ goes LOW.

Signal S₀ delivers 1/255 of the possible power to the pixel;

Signal S₁ delivers 2/255 of the possible power to the pixel;

Signal S₂ delivers 4/255 of the possible power to the pixel;

Signal S₃ delivers 8/255 of the possible power to the pixel;

Signal S₄ delivers 16/255 of the possible power to the pixel;

Signal S₅ delivers 32/255 of the possible power to the pixel;

Signal S₆ delivers 64/255 of the possible power to the pixel;

Signal S₇ delivers 128/255 of the possible power to the pixel.

As noted above, the number of S Signal lines is not restricted to eight lines but can be as many or as few as are required to achieve the desired gray scale levels. For example, with sixteen S Signal lines, 65,536 level of gray scale are possible (zero luminosity plus 65,535 levels of gray). As more S Signal lines are added, each S Signal is 2 times longer than the previous S Signal and starts when the previous S Signal goes LOW. Therefore, as a new S Signal is added, the previous S Signal power levels are reduced by ½. Below are the signal relationships for a ten signal system:

Signal S₀-1X time period HIGH, starting at the beginning of the cycle and delivers 1/1023 of the possible power to the pixel;

Signal S₁-2X time periods HIGH, starting when Signal S₀ goes LOW and delivers 2/1023 of the possible power to the pixel;

Signal S₂-4X time periods HIGH, starting when Signal S₁ goes LOW and delivers 4/1023 of the possible power to the pixel;

Signal S₃-8X time periods HIGH, starting when Signal S₂ goes LOW and delivers 8/1023 of the possible power to the pixel;

Signal S₄-16X time periods HIGH, starting when Signal S₃ goes LOW and delivers 16/1023 of the possible power to the pixel;

Signal S₅-32X time periods HIGH, starting when Signal S₄ goes LOW and delivers 32/1023 of the possible power to the pixel;

Signal S₆-64X time periods HIGH, starting when Signal S₅ goes LOW and delivers 64/1023 of the possible power to the pixel;

Signal S₇-128X time periods HIGH, starting when Signal S₆ goes LOW and delivers 128/1023 of the possible power to the pixel;

Signal S₈-256X time periods HIGH, starting when Signal S₇ goes LOW and delivers 256/1023 of the possible power to the pixel;

Signal S₉-512X time periods HIGH, starting when Signal S₈ goes LOW and delivers 512/1023 of the possible power to the pixel.

Since it is particularly suited to binary applications, the weight of the period “X” is selected in this embodiment as a power of 2 (i.e., X=2ⁿ), although as described above, any weight value may be used.

In FIG. 8A, an embodiment of the invention used to drive the gray scale of a plurality of pixel elements in a display is illustrated. As many gray scale drivers 1210a-b as are needed to drive the pixels in the display are coupled to an S signal bus 1212. For example, each sub-pixel (RGB) may have its own gray scale driver in an active matrix configuration or each column of sub-pixels (RGB) may have its own gray scale driver in a multiplexed configuration,. In this embodiment, each gray scale driver 1210a-b includes a pre-load n-bit data latch 1214a-b that is coupled to a process n-bit latch 1216a-b. The process n-bit latch 1216a-b is coupled to a generation circuit 1220a-b. The generation circuit 1220a-b is coupled to a pixel driver 1222a-b, to which the generation circuit 1220a-b provides a combined S signal 512 such as is illustrated in FIG. 4B. The S signal bus 1212, the process n-bit data latches 1216a-b, the pixel drivers 1222a-b and the generation circuits 1220a-b, are substantially similar to those described above with reference to FIGS. 5 and 6.

In operation, during a current S cycle the pixel driver 1222a-b is coupled to a composite S signal 1224a-b that is generated by the generation circuit 1220a-b in response to a plurality of data bit values that appear on corresponding outputs 1224a-f and 1225a-f of the process n-bit latch 1216a-b. The operation of the generation circuit 1220a-b is described in detail above with reference to FIGS. 5 and 6, but to review briefly the generation circuit selects corresponding constituent S signals from the S signal bus 1212 and outputs a composite S signal made up of the selected constituent S signals to the pixel drive 1222a-b. The generation circuit shown in FIG. 8A utilizes AND logic gates with output circuits connected in a WIRED OR configuration with resistor 1026a-b.

While the gray scale driver circuit outputs the composite S signal to the pixel driver 1222a-b, the pre-load n-bit latch 1214a-b is loaded with a data word 1230a-b that represents a desired duty cycle for the combined S signal to be sent to the pixel driver 1222a-b during a next S cycle. At or near the start of the next S cycle, the data word 1230a-b is transferred from the pre-load n-bit latch 1214a-b to the process n-bit latch 1216a-b. The generation circuit 1220a-b generates the combined S signal for the pixel driver 1222a-b when the next S cycle becomes the current S cycle. In this way, the pre-load n-bit latch 1214a-b loads the data word 1230a-b for the duty cycle of the desired gray scale which will be displayed by the pixel during the next S cycle, while the process n-bit latch 1216a-b holds the data that the generation circuit uses to generate the combined S signal for the driver 1222a-b during the current S cycle.

FIG. 8B illustrates another embodiment of a gray scale driver circuit formed in accordance with the present invention. The operation of the circuit in FIG. 8B is essentially the same as just described for FIG. 8A but it pre-loads the data word differently. In this embodiment, each gray scale driver 1210a-b loads the data word 1230a-b for the next S cycle directly into the n-bit process latch 1216a-b (bypassing the pre-load n-bit latch 1216a-b in the embodiment of FIG. 8A) at a precise S cycle period during the current S cycle. The generation circuit 1220a-b generates the combined S signal for the pixel driver 1222a-b when the next S cycle becomes the current S cycle. The generation circuit shown in FIG. 8B utilizes AND logic gates with output circuits connected in a WIRED OR configuration with resistor 1026a-b.

In place of the pre-load n-bit latch 1216a-b in the embodiment of FIG. 8A, in FIG. 8B a single bit latch 1218a-b is coupled to an output 1219a-b of the data bit that corresponds to the S signal 1240 having the longest period (or any other S signal having a period long enough to load the data word 1230). The single bit latch 1218a-b is also coupled to an AND gate 1250a-b in the generation circuit 1220a-b also corresponding to the S signal 1240 having the longest period (or any other S signal having a period long enough to load the data word 1230).

Referring to FIGS. 7B, S signal S₇ 1154 has the longest period of the set of S signals, equaling approximately half the time allotted to the S cycle (128/255). At or before the time S signal S₇ 1154 goes HIGH, the bit value at output 1219a-b (FIG. 8B) is loaded into the data latch 1218a-b. During the period that S signal S₇ 1154 is HIGH, the value stored by the data latch 1218a-b is used by the AND gate 1250a-b to decide whether to combine the S signal S₇ 1154 signal into the composite signal. Also during the S signal S₇ 1154 period, the other AND gates 1252a-b are disabled and the data word 1230a-b for the next S cycle is loaded into the process n-bit latch 1216a-b.

In this way, data latch 1218a-b takes the place of the pre-load n-bit latch 1214a-b shown in FIG. 8A by allowing the new data for the next S cycle to be loaded directly into the process n-bit latch 1216a-b during the S₇ period when the S₀-S₆ output lines of the process n-bit latch 1216a-b are not used because the S signals S₀-S₆ are no longer HIGH. Any changes which occur on the S₀-S₆ output lines of the process n-bit latch 1216a-b during the S₇ period are ignored by the generation circuit 1220a-b and any change that occurs on the S₇ output line of the process n-bit latch 1216a-b during the S₇ period does not affect the generation circuit 1220a-b because the current S cycle data is stored in data latch 1218a-b.

While the preferred embodiment of the invention has been illustrated and described, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

I claim:

1. A method for generating a pulse width modulated signal with a variable duty cycle, comprising:
inputting a data word as a variable that represents a desired duty cycle of the pulse width modulated signal to be generated, the data word comprising a plurality of data bits, each data bit having at least one of a selected or unselected state;
inputting a plurality of constituent pulse width modulated signals, each constituent pulse modulated signal being associated with a data bit in the data word; and
generating a pulse width modulated signal by combining each constituent pulse width modulated signal that corresponds to a data bit in the data word that indicates the selected state.

2. The method of claim 1, wherein each constituent pulse width modulated signal has an ON portion that is unique during a common period shared by the constituent pulse width modulated signals.

3. The method of claim 2, wherein the ON portion of each constituent pulse width modulated signal is binary weighted so that the ON portion of each of the constituent pulse width modulated signals is related by a unique power of 2 to the ON portion of each other of the constituent pulse width signals.

4. The method of claim 3, wherein the ON portions of the constituent pulse width modulated signals are ordered in time according to their binary weight.

5. The method of claim 4, wherein the constituent pulse width modulated signal having the ON portion with the greatest magnitude occurs at the end of the common period.

6. A programmable pulse width modulation generator circuit for generating a pulse width modulated signal with a variable duty cycle, comprising:
a data loading circuit for receiving a data word representing the desired duty cycle of the pulse width modulated signal to be generated, the data word comprises a plurality of data bits, each bit having at least one of a selected or unselected state;
a generating circuit coupled to data loading circuit for receiving a plurality of periodic pulse width modulated signals, and for generating a pulse width modulated signal by combining each constituent pulse width modulated signals that correspond to a data bit in the data word that indicates the selected state.

7. The programmable pulse width modulation generator circuit of claim 6, wherein each constituent pulse width modulated signal has an ON portion that is unique during a common period shared by the constituent pulse width modulated signals.

8. The programmable pulse width modulation generator circuit of claim 7, wherein the ON portion of each constituent pulse width modulated signal is binary weighted so that the ON portion of each of the constituent pulse width modulated signals is related by a unique power of 2 to the ON portion of each other of the constituent pulse width signals.

9. The programmable pulse width modulation generator circuit of claim 8, wherein the ON portions of the constituent pulse width modulated signals are ordered in time according to their binary weight.

10. The programmable pulse width modulation generator circuit of claim 9, wherein the constituent pulse width modulated signal having the ON portion with the greatest magnitude occurs at the end of the common period.
